(19) United States
(12) Patent Application Publication
(10) Pub. No.: US 2006/0169157 A1
(43) Pub. Date: Aug. 3, 2006

(54) Inking unit

(75) Inventor: Stuart Gahan, Lancs (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Goss Graphic Systems Limited, Preston, Lancashire (GB)

(21) Appl. No.: 10/545,780

(22) PCT Filed: Jan. 22, 2004
(86) PCT No.: PCT/GB04/00245

§ 371 Date: Aug. 16, 2005

(30) Foreign Application Priority Data
Feb. 17, 2003 (GB) 0303629.0

(51) Int. Cl. B41F 31/02

(52) U.S. Cl. 101/365

(57) ABSTRACT

An inking unit for a printing press is disclosed. It comprises a plurality of forme cylinders (9,10) operable to feed ink onto a plate cylinder (3) of a printing press and a separate ink distribution drum (15,16) associated with each forme cylinder operable to feed ink to each forme cylinder (9,10) respectively.

The present invention relates to an inking unit for a printing press and, more specifically, to an inking unit or inker for a rotary offset printing machine.

A rotary printing machine includes a plate cylinder and a blanket cylinder. Printing plates are mounted to the plate cylinder for transferring an inked image to the blanket cylinder which contacts the print medium to print the resulting image. Ink is fed to the printing plates mounted on the plate cylinder by an inking unit. The inking unit of a conventional offset printing press comprises a train of ink rollers including two or three forme rollers in rolling engagement with the printing plates mounted on the plate cylinder. The forme rollers are operable to feed ink to the printing plates as the plate cylinder rotates. Printing ink is supplied to the forme rollers via the train of ink rollers from an ink fountain.

In a conventional press having two forme rollers, each forme roller is in rolling engagement with a main ink distribution drum. Ink is fed to the main ink distribution drum from an ink fountain via an auxiliary drum and transfer rollers and is transferred from the main ink distribution drum to the forme rollers. Means are provided to cause both the main ink distribution drum and the auxiliary ink distribution drum to oscillate along their axes i.e. along the width of the printing press, as they rotate to transfer ink to the forme rollers and main ink drum respectively. Oscillation of the main and auxiliary ink distribution drums causes the ink to move laterally in a direction across the width of the press to ensure even distribution of the ink across the forme rollers and, consequently, across the ink receptive areas of the printing plate. It is also known to provide a printing press with three forme rollers. A three forme ink train has the same construction as a two forme ink train except that there is an additional forme roller in rolling engagement with the plate cylinder and an additional main ink distribution drum in contact with the additional forme roller. Conventionally, a two form toilet press has been used for newspaper printing. However, a demand for better print quality has meant that three forme roller presses are now more commonly used.

It is well understood in the printing industry that printed images printed using printing presses having a inking unit of the type of construction described above suffer from a variation in localised print density in the across press direction when solid images are printed and there is an abrupt change in the printed image area across the page. This print defect is commonly known in the industry as “starvation”. This problem primarily occurs when printing an image having two portions adjacent to each other and one of said portions extends angularly relative to the other portion. The printing plate therefore has abutting ink receptive areas, a large ink receptive area that extends circumferentially around the plate cylinder and, a smaller ink receptive area that extends axially across the plate cylinder. An example of an image of this type which is often a requirement of newspapers or magazines is a picture frame comprising a pair of horizontal and a vertical components representing a low and high percentage of ink receptive area respectively. The effect of starvation is that one portion of the image is not the same shade as the other portion, i.e. the horizontal component of the image which has the lower percentage of ink receptive area appears to be darker than the vertical image having the higher percentage of ink receptive area in the region of the join between the two components.

It is important to note that, although there is some under supply of ink to the vertical component or larger ink receptive area of the image, starvation is primarily an over supply of ink to the horizontal component or the smaller ink receptive area making it appear darker than the vertical component or larger ink receptive area. However, the appearance of the printed image suggests that there has been an under supply of ink to the vertical component or that it has been “starved” of ink.

The reason for the above print defect is generally because the inking units are based on controlling the ink feed to zones which represent columns in the direction of print. The feed to individual zones is set by adjusting an ink key to vary the amount of ink fed to each zone. The ink key must be set to satisfy the printed area within each zone. However, where there are adjacent abrupt coverage changes within the same zone, such as in the circumstances described above, there exists two ink feed requirements but only one ink feed key. The result is that the ink feed key is set to satisfy the larger coverage area and the smaller coverage area receives too much ink.

Attempts can be made to increase the amount of ink supplied to the larger coverage area or the portion of the image which has the greatest circumferential extent around the cylinder. Typically, this involves controlling the ink key to increase the ink feed to compensate for the apparent under supply of ink to the larger coverage area. However, to date a satisfactory solution to the problem has not yet been found. On the contrary, the action of increasing the ink feed by controlling the ink key merely compounds the problem as the horizontal component is overfed to an even greater extent.

Another widely known limitation of conventional inking units is that the zones are usually in the region of 50 mm wide and so the ink is fed by each ink key onto the roller in bands each of 50 mm in width. However, the vertical component of the image may only be in the region of 20 mm wide. When the ink is fed in, for example, a 50 mm wide strip but the ink receptive area is a much narrower strip, say for example, 20 mm, a portion of the ink intended to be fed to the vertical component does not reach its target and remains outside the 20 mm strip and migrates laterally across zones to affect the ink feed in other zones. The migration of ink into other zones has a detrimental affect on the appearance and quality of the resulting printed image.

Although oscillation of the main and auxiliary ink drums causes the ink film to move laterally on the ink drums and thereby serves to partially alleviate the aforementioned problem, it has been found that migration of ink does still occur to an unsatisfactory extent.

The present invention seeks to overcome or alleviate the aforementioned problems with a conventional inking unit of a rotary printing press.

According to the present invention, there is provided an inking unit comprising a plurality of forme cylinders operable to feed ink onto a plate cylinder of a printing press and a separate ink distribution drum associated with each forme cylinder operable to feed ink to each forme cylinder respectively.

In a preferred embodiment, means are provided to cause at least two ink distribution drums to oscillate in the axial direction during rotation. As there is a separate ink distribution drum feeding ink to a corresponding forme roller, the oscillation of an increased number of ink distribution drums results in a higher effective oscillation frequency. This ensures that mote of the ink intended for the vertical component of the image actually finds its target rather than migrating across zones to affect the ink feed in other columns. As the surplus ink is finding its target as a result of the increased oscillation frequency provided by the oscillation of at least two ink distribution rollers each in rolling engagement with one forme roller, the vertical component of the image is now receiving more ink which reduces the apparent starvation effect and consequently, the extend to which the ink key may have to be adjusted to increase the supply of ink. In addition, as more of the surplus ink is reaching the vertical component, there is less surplus ink to overfeed the horizontal component which further reduces the effect of starvation to the vertical component.

Preferably, means ate also provided to control the frequency at which each ink distribution drum oscillates independently of the remaining ink distribution drums.

In one preferred embodiment, the inking unit comprises first and second forme cylinders and first and second ink distribution drums associated with the first and second forme cylinders respectively. An advantage of this arrangement is that the print quality is comparable to that obtained when a three forme inking unit is used. However, as there is still only two forme rollers in rolling engagement with the plate cylinder, the accessibility of the plate cylinder for plate changes and maintenance is maintained. Furthermore, the use of three forme rollers is not always possible, especially with a “one around” plate cylinder (a plate cylinder capable of carrying only one plate) because the diameter of the plate cylinder is just too small to enable three forme cylinders to be positioned against it.

In the preferred embodiment, means are provided to cause the first and second ink distribution drums to oscillate in the axial direction during rotation.

Preferably, the inking unit includes an auxiliary ink distribution drum to receive ink from an ink fountain and arranged so as to feed ink to each ink distribution drum.

Advantageously, intervening ink transfer rollers are disposed between the auxiliary ink distribution drum and each distribution drum.

The inking unit may also include means to enable oscillation of the auxiliary ink distribution roller in an axial direction during rotation.

The present invention also relates to a rotary printing press incorporating the inking unit according to the invention.

The printing press preferably includes a plate cylinder configured to receive a single printing plate, the diameters of the plate cylinder and at least one forme cylinder being the same.

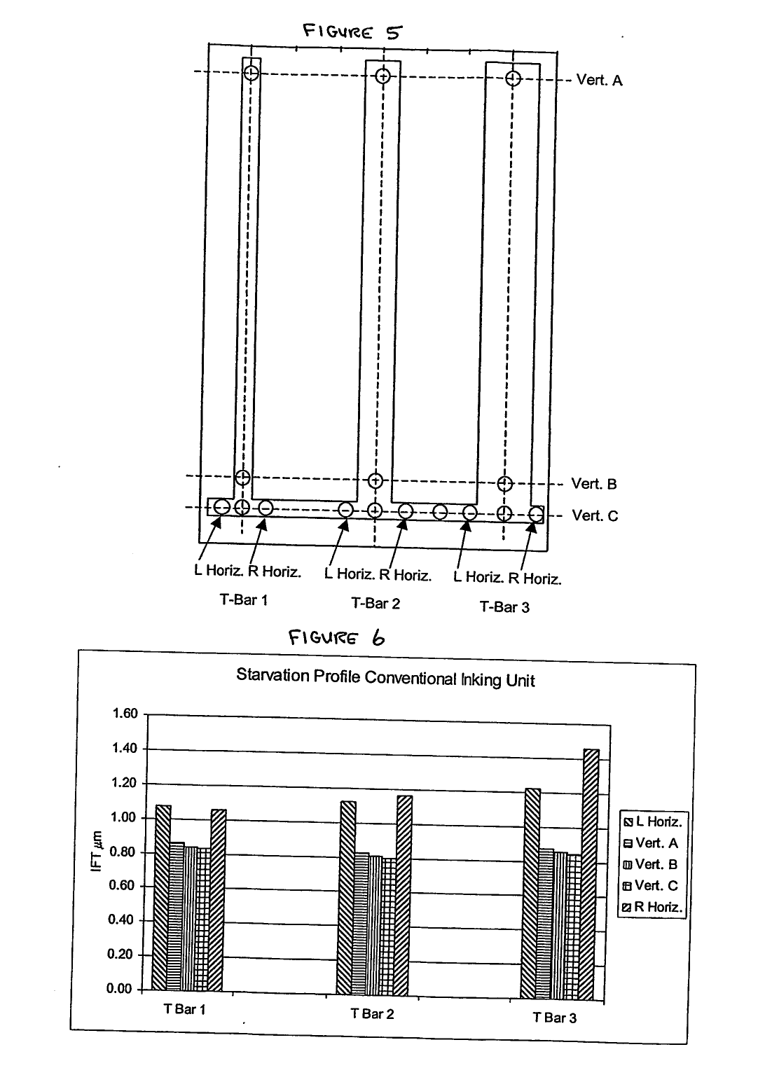

An embodiment of the invention will now be described, by way of example only, with reference to FIGS. 5,7 and 8 of the accompanying drawings, in which:—

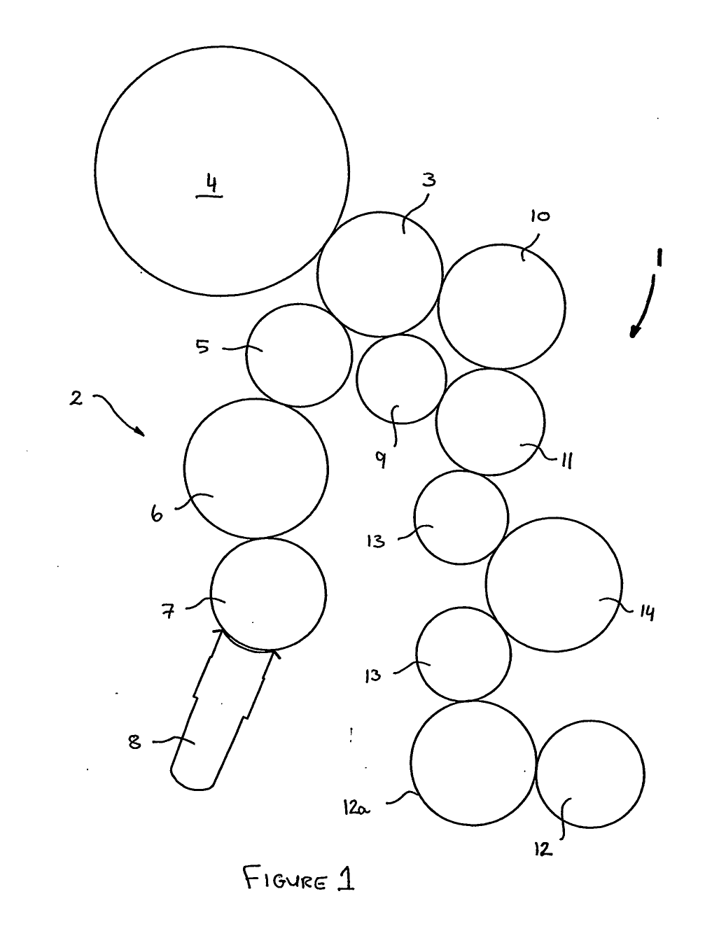

FIG. 1 illustrates a schematic side view of a portion of a rotary printing press having an inker with two forme rollers according to the prior art;

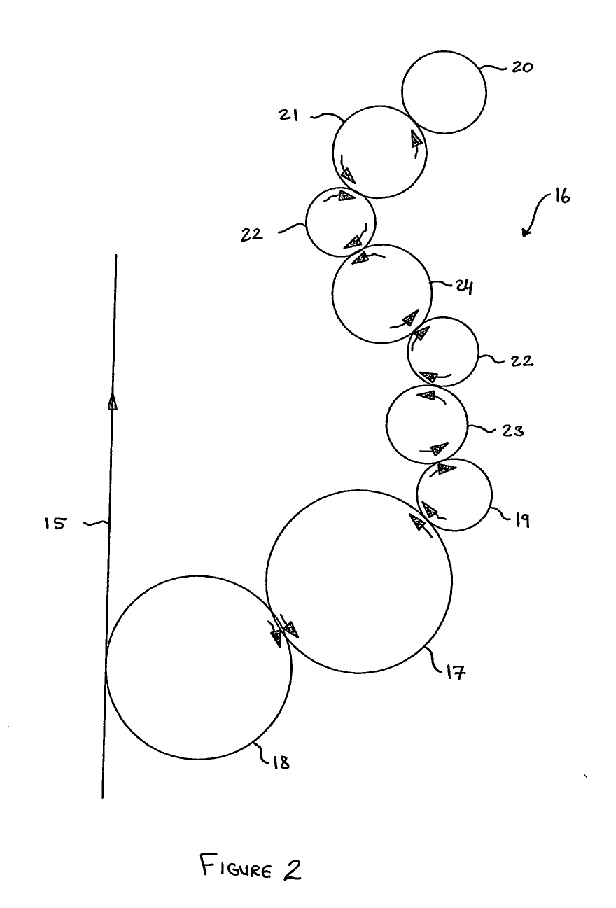

FIG. 2 illustrates aschematic side view of a portion of a rotary printing press having an inker with a single forme roller according to the prior art;

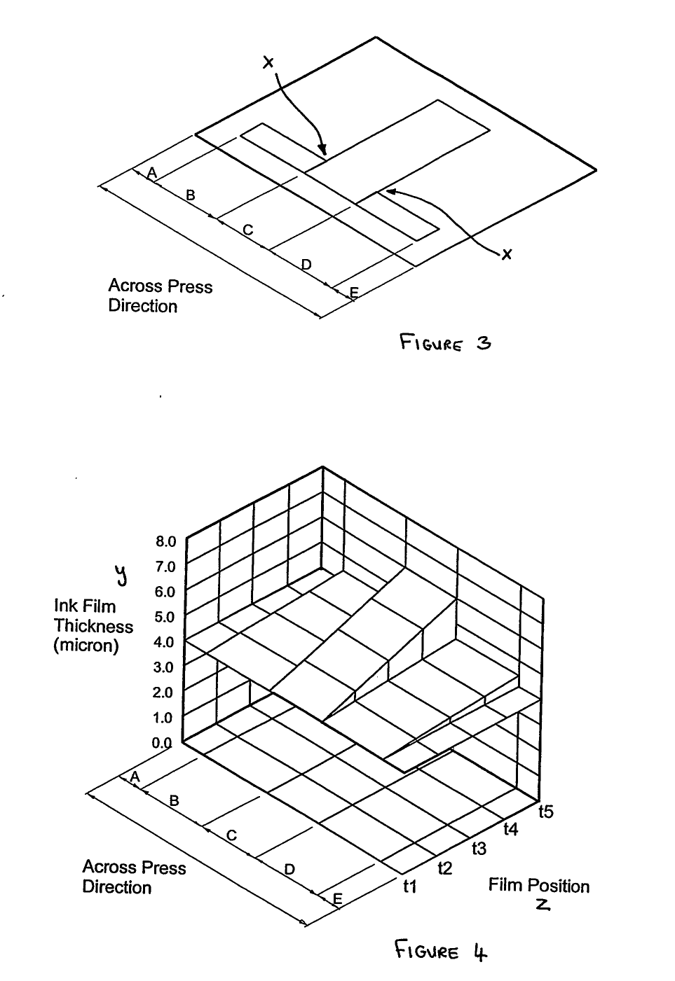

FIG. 3 illustrates a printed image having an abrupt change in ink coverage to demonstrate the effect of starvation;

FIG. 4 illustrates the ink films required at the different roller positions to print the image using a conventional ink train such as that illustrated in FIG. 2;

FIG. 5 shows another image having an abrupt change in ink coverage;

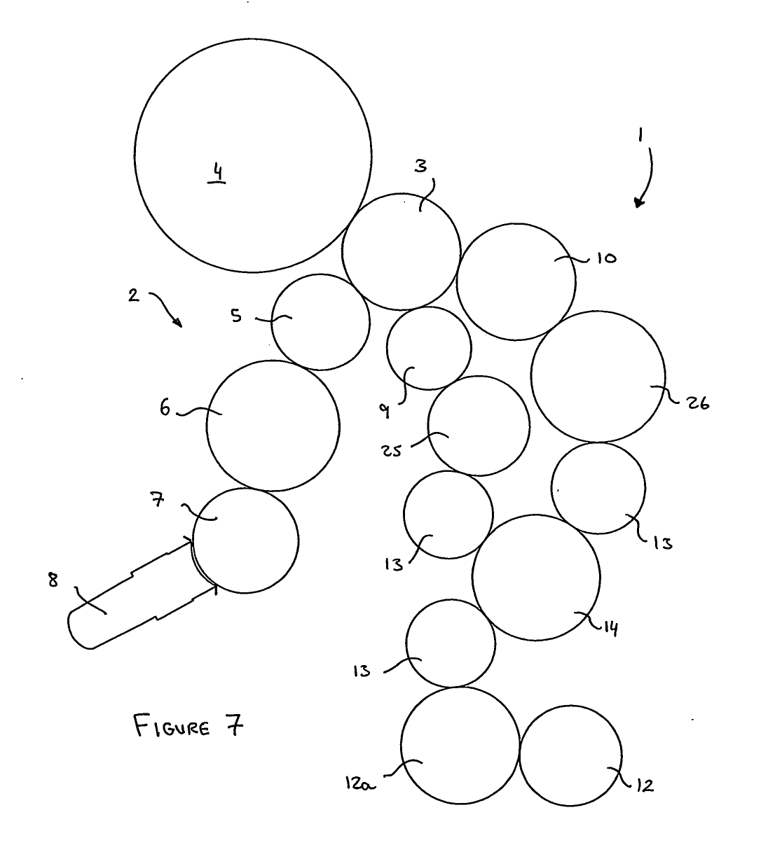

FIG. 6 shows a graph to illustrate the performance of a conventional inking unit;

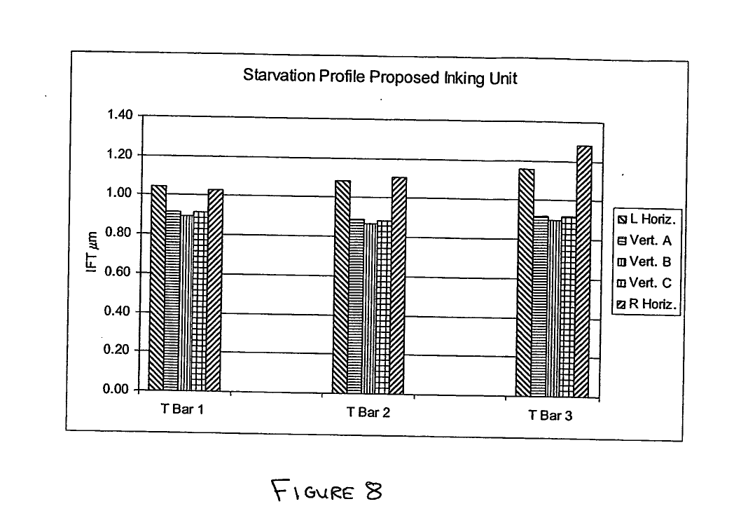

FIG. 7 illustrates a schematic side view of a portion of a rotary printing press having an inking unit according to the invention;

FIG. 8 shows a graph to illustrate the performance of the inking unit of the press shown in FIG. 7.

Referring now to FIG. 1, there is shown a schematic view of a conventional two forme ink train 1 and dampening unit 2 both of which extend away from a plate cylinder 3 in rolling engagement with a blanket cylinder 4. The plate cylinder 3 and blanket cylinder 4 together form one print couple of the printing press.

The dampening unit 2 is of a conventional construction and comprises a water forme roller 5 in rolling contact with the plate cylinder 3 and an oscillating roller 6 in contact with the water forme roller 5. The oscillating roller 6 is fed with water from a water rider 7 which is located adjacent to a dampening spraybar 8 and which receives water emitted therefrom. The amount of water supplied to the water rider roller 7 and water forme roller 5 is controlled by the frequency of operation of valves (not shown) within the spraybar 8. As the dampening unit 2 is of conventional construction, no further description of it is necessary.

The inking unit 1 will now be described and comprises a pair of forme cylinders 9,10 in rolling contact with the plate cylinder 3. A main ink distribution drum 11 is located in rolling engagement with both of the forme cylinders 9,10 so that ink is transferred from the main ink distribution drum 11 to both forme cylinders 9,10. Ink is supplied to the main ink distribution drum 11 from an ink fountain roller 12 partially immersed in an ink bath (not shown). As an alternative to an ink fountain roller 12, digital page packs (not shown) may be used in which case the ink is injected through a valve which is opened and closed in response to a control signal. Ink is transferred to the main ink distribution drum 11 via a pick-up roller 12a, transfer rollers 13 and an auxiliary ink distribution drum 14, although it will be appreciated that the transfer roller 13 and pick-up roller 12a could be omitted so that the fountain roller 12 is directly adjacent to the auxiliary ink distribution drum 14. Means are provided to cause both the main and auxiliary ink distribution drums 11,14 to oscillate in an axial direction to cause the ink to move laterally and distribute it evenly over the forme cylinders 9,10. Many devices to control oscillation of the main and auxiliary ink distribution drums 11,14 are known in the printing industry and so no explanation of such a device will be made here.

The ink feed of the inking unit 1 is controlled using ink keys (not shown). Each ink key controls the ink to a corresponding zone that represent columns in the direction of print. The ink feed to individual zones is set by adjusting the ink keys for each zone to vary the amount of ink fed to each zone. The ink key for a particular zone is set to satisfy the printed area within that zone.

The conventional inking unit described above and illustrated in FIG. 1 is susceptible to the problem of ink starvation when solid images are printed and there is an abrupt change in the printed image area across the page within a zone. This is because there is only one ink key for each zone, which is set to satisfy the larger coverage area, but two ink feed requirements. As the ink key is set to satisfy the larger coverage area, the smaller coverage area receives too much ink.

The effect of starvation will be further explained with reference to FIGS. 2 to 6. FIG. 2 illustrates part of a printing press 16 comprising a plate 17 and blanket cylinder 18 in contact with a paper web 15. The press shown is a simplified version of the press shown in FIG. 1 because it has only a single forme roller 19 in rolling engagement with the plate cylinder 17 which is fed with ink from an ink fountain roller 20 via a pick-up roller 21, transfer rollers 22 and main and auxiliary ink distribution rollers 23,24. An example of a solid printed image printed using the press shown in FIG. 2 and in which starvation has occurred is shown in FIG. 3. The image contains four regions in the across press direction namely, a region designated “A” having an ink coverage area of 0%, a region designated “B” having an ink coverage area of 10%, a region designated “C” having an ink coverage area of 50% and, a region designated “D” having an ink coverage area of 0%. If all these regions are contained within a zone covered by a single ink key, a printed density difference appears locally at the boundary of regions B and C and the boundary of regions C and D (indicated by “X”). The smaller printed area will appear darker than the larger printed area.

FIG. 4 illustrates the ink film thickness required at different roller positions to print the image of FIG. 3 with an ink film on the web of 1 μm using an ink train such as that illustrated in FIG. 2. On the graph, the x-axis represents the distance across the width of the press, the y-axis represents the ink film thickness in microns and the z-axis represents the ink film position at different roller positions. Analysis of the different ink feed gradients for areas B, C and D demonstrates that the ink requirement for these image regions cannot be met by a single ink key which can provide ink at only one supply rate.

Although the effect of starvation has been explained with reference to an inking unit with a single forme roller such as that illustrated in FIG. 2, the problem is also encountered when an inking unit having two forme rollers, such as that illustrated in FIG. 1, is used.

An ink simulation program has been used to demonstrate the performance of the conventional two forme ink train and the results, when the press is used to print the image shown in FIG. 5, are shown in the graph of FIG. 6. It can be seen that the three measurements taken on the vertical (A, B and C) fall short of the optimum value of 1.00. This is because of the inability of the system to feed enough ink into the correct part of the image. The measurements on the horizontal either side of the vertical are above the required level. The degree of overfeed/underfeed to the image is related to the vertical to horizontal image area ratio.

Referring now to FIG. 7, there is illustrated a two forme inking unit according to the present invention. The dampening unit 2 is identical to the conventional dampening unit described with reference to FIG. 1 and so will not be described again. The inking unit 1 of the present invention is also associated with the plate cylinder 3 of the printing press. The inking unit 1 differs from the known inking unit 1 described with reference to FIG. 1 above in the construction of the ink train between the auxiliary ink distribution drum 14 and the forme rollers 9,10. Instead of a single transfer roller feeding ink to the main ink distribution drum 11 which in turn feeds ink to both forme rollers 9,10, the auxiliary ink distribution drum 14 is in rolling engagement with two transfer rollers 13 each of which are in rolling contact with their own corresponding ink distribution drum 25,26. Each ink distribution drum 25,26 is in contact with one of the forme rollers 9,10. Therefore, it will be appreciated that ink is supplied to each form roller from the auxiliary ink distribution roller 14 via separate, discrete or independent paths by a transfer roller 13 and an ink distribution roller 25,26 associated with each forme roller 9,10. The forme rollers 9,10 may be of different diameters and, in particular, the second forme roller 10 may be of the same diameter as the plate cylinder 3, even in a one around press in which the plate cylinder 3 carries only a single printing plate.

Means are provided to cause the ink distribution drums 25,26 to oscillate in an axial direction together with the auxiliary ink distribution drum either at the same or at a different frequency to the auxiliary ink distribution drum 14.

The ink simulation program has also been performed on the inking system forming the subject of the present invention, such as that illustrated in FIG. 7, when printing the image shown in FIG. 5, and the results are shown in FIG. 8. It can be seen that the values achieved in the vertical component of the image are much closer to the required level of 1.00. Similarly, the measurements taken either side of the vertical ate also much closer to the requited level. The net result is a much more even ink film when printing images with abrupt changes in coverage areas.

It will be appreciated that the inking unit of the present invention not only reduces the starvation effect but also alleviates the problems caused by migration of surplus ink fed into one zone into adjacent zones.

Many modifications and variations of the invention falling within the terms of the following claims will be apparent to those skilled in the art and the foregoing description should be regarded as a description of the preferred embodiments only.

1-11. (canceled)

12. An inking unit for a rotary offset printing machine the inking unit comprising a plurality of ink keys, each ink key being adjustable to control the ink feed to individual zones located adjacent to each other across the width of a plate cylinder of a printing machine to which ink is being fed by the inking unit, the inking system further comprising a roller train including a plurality of forme cylinders operable to feed ink from the inking unit to said zones on a plate cylinder, a separate ink distribution drum associated with each forme cylinder operable to feed ink to each forme cylinder respectively and, an auxiliary ink distribution roller for supplying ink to each of the ink distribution drums, the roller train being configured so that ink is supplied to each forme roller from the auxiliary ink distribution roller via independent paths, the inking unit including means to cause each ink distribution drums to oscillate in an axial direction during rotation to reduce a variation in print density within each zone in a direction extending across the plate cylinder of the printing machine, when printing solid images having abrupt changes in image area.

13. An inking unit according to claim 12 wherein means are provided to control the frequency at which each ink distribution drum oscillates independently of the remaining ink distribution drums.

14. An inking unit according to claim 12 comprising first and second forme cylinders and first and second ink distribution drums associated with the first and second forme cylinders respectively.

15. An inking unit according to claim 12 wherein the auxiliary ink distribution roller receives ink from one of an ink fountain and press pack.

16. An inking unit according to claim 12 wherein intervening ink transfer rollers are disposed between the auxiliary ink distribution roller and each ink distribution drum.

17. An inking unit according to claim 12 comprising means to oscillate the auxiliary ink distribution roller in an axial direction during rotation.

18. A rotary printing press incorporating the inking unit according to claim 12.

19. A rotary printing press according to claim 18 including a plate cylinder configured to receive a single printing plate and wherein the diameters of the plate cylinder and at least one forme cylinder are the same.

20. A method of controlling an inking unit for a rotary offset printing machine comprising a plurality of ink keys, each ink key being adjustable to control the ink feed to individual zones located adjacent to each other across the width of a plate cylinder of the printing machine to which ink is being fed by the inking unit, the inking system further comprising a roller train including a plurality of forme cylinders operable to feed ink from the inking unit to the zones on the plate cylinder, a separate ink distribution drum associated with each forme cylinder operable to feed ink to each forme cylinder respectively and an auxiliary ink distribution roller for supplying ink to each of the ink distribution drums, the roller train being configured so that ink is supplied to each forme roller from the auxiliary ink distribution roller via independent paths, the method including the step of oscillating each ink distribution drums in an axial direction during rotation to reduce a variation in print density within each zone in a direction extending across the plate cylinder of the printing machine when printing solid images having abrupt changes in image area.
